(19) United States
(12) Patent Application Publication
(10) Pub. No.: US 2026/0086315 A1
(43) Pub. Date: Mar. 26, 2026

(54) COMPACT RANGING AND IMAGING INTEGRATED LENS

(71) Applicant: ZHEJIANG ZHAOSHENG TECHNOLOGY CO., LTD., Zhejiang (CN)

(72) Inventors: Yong TANG, Zhejiang (CN); Jinwei GAO, Zhejiang (CN); Junhang JIN, Zhejiang (CN)

(73) Assignee: ZHEJIANG ZHAOSHENG TECHNOLOGY CO., LTD., Zhejiang (CN)

(21) Appl. No.: 19/001,509

(22) Filed: Dec. 25, 2024

(30) Foreign Application Priority Data
Sep. 20, 2024 (CN) 202411313865.3

(51) Int. Cl. G02B 7/09; G01S 7/481; G02B 7/02; H04N 23/20; H04N 23/55; H04N 23/56

(52) U.S. Cl. CPC G02B 7/09; G01S 7/4813; G02B 7/021; G02B 7/022; G02B 7/026; H04N 23/20; H04N 23/55; H04N 23/56

(57) ABSTRACT

A compact ranging and imaging integrated lens includes an infrared imaging part and a ranging part. The ranging part is integrated in an infrared imaging lens, and a laser transmitting lens set and a laser receiving lens set are mounted on an edge of a lens holder and separated from each other, such that the laser transmitting lens set and the laser receiving lens set will not occupy space beyond the area where a first lens is located, and will not form obvious protrusions on the outside of the compact ranging and imaging integrated lens, thus making the compact ranging and imaging integrated lens more compact in overall structure, reducing the influence on infrared imaging and mutual interference between components, and improving the ranging accuracy of the compact ranging and imaging integrated lens.

### CROSS-REFERENCE TO RELATED APPLICATIONS

This application claims the priority benefit of China application no. 202411313865.3 filed on Sep. 20, 2024. The entirety of each of the above-mentioned patent applications is hereby incorporated by reference herein and made a part of this specification.

### BACKGROUND OF THE INVENTION

### 1. Technical Field

The invention relates to an imaging integrated lens, in particular to a compact ranging and imaging integrated lens.

### 2. Description of Related Art

Handheld optical imaging devices for outdoor sports, such as handheld infrared thermal imaging telescopes, adopt ranging devices, such as laser ranging devices, to satisfy user's requirements for obtaining distance data of a target. Sights for accurate shooting, such as infrared thermal imaging sights, are generally equipped with a laser ranging device to calibrate the distance to a target so as to improve shooting accuracy.

The laser ranging device typically comprises a laser signal transmitting system, an optical system, a target reflected signal measurement optical system drive circuit, a signal processing circuit board and fixed structural members.

In the prior art, an imaging and laser ranging device is generally formed by combining and using together a laser ranging device and an optical observation device, wherein the laser ranging device is hung and fixed to the outside of the optical observation device to be connected to the optical observation device, which means that the laser ranging device is hung and fixed to a shell of the optical observation device, and the laser ranging device is separated from optical modules on the optical observation device. By adopting such an arrangement, the laser ranging device will protrude with respect to the optical observation device, thus increasing the external size of the laser ranging device and reducing the portability of the device.

### BRIEF SUMMARY OF THE INVENTION

The technical issue to be settled by the invention is to provide a compact ranging and imaging integrated lens to solve the technical problem that an externally mounted device affects the size and using effect of a lens in the prior art.

The technical solution of the invention is as follows: a compact ranging and imaging integrated lens, comprising an infrared imaging part and a ranging part.

The technical solution of the invention is as follows: wherein the infrared imaging part comprises a first lens, a second lens, a focusing module and a lens holder, the first lens is mounted on the lens holder, the second lens is mounted on the focusing module, the ranging part comprises a laser transmitting lens set, a laser receiving lens set and a control processing module, the control processing module comprises a laser transmitting module, a laser receiving module and a control processing circuit board, the laser transmitting module and the laser receiving module are arranged on the control processing circuit board, the laser transmitting lens set and the laser receiving lens set are mounted on an edge of the lens holder and separated from each other, a first recess matched with the laser transmitting lens set and a second recess matched with the laser receiving lens set are formed in an edge of the first lens, and the control processing module is arranged behind the lens holder and located beyond an infrared imaging light path of the infrared imaging part.

According to a further technical solution of the invention, wherein a first mounting cavity and a second mounting cavity are formed in the lens holder, the laser transmitting lens set is mounted in the first mounting cavity, and the lens receiving lens set is mounted in the second mounting cavity.

According to a further technical solution of the invention, wherein the control processing circuit board is ring-shaped.

According to a further technical solution of the invention, wherein the laser transmitting module and the laser receiving module are arranged at two opposite ends of the control processing circuit board, and the laser transmitting lens set and the laser receiving lens set are correspondingly arranged at two opposite ends of the lens holder.

According to a further technical solution of the invention, wherein the focusing module comprises a main tube, a focusing tube and a focusing lens holder, the second lens is arranged on the focusing lens holder, and a spring is arranged between the focusing lens holder and the main tube.

According to a further technical solution of the invention, further comprising an outer tube, wherein a gear ring is arranged on an outer side of the focusing tube, a rotation driving mechanism comprises a focusing gear rotatably connected to the outer tube, the focusing gear is engaged with the gear ring on the focusing tube, and a rotary wheel is connected to the focusing gear.

According to a further technical solution of the invention, wherein the focusing lens holder is slidably connected to the main tube and arranged in the focusing tube, and the focusing tube is in thread fit with the focusing lens holder.

According to a further technical solution of the invention, wherein extensions are arranged at an end, away from the lens holder, of the main tube and extend in an axial direction of the main tube, guide grooves are formed between adjacent said extensions, guide protrusions are arranged on an outer side of the focusing lens holder, and the guide protrusions are clamped in the guide grooves and are able to slide along the guide grooves.

According to a further technical solution of the invention, wherein the focusing lens holder is arranged in the focusing tube and slidably connected to the main tube, and the focusing tube is in thread fit with the focusing lens holder.

According to a further technical solution of the invention, further comprising an outer tube, wherein the outer tube has an end connected to the lens holder and an end fixedly connected to the outer tube, the focusing tube is arranged between the outer tube and the focusing lens holder, and a rotation driving mechanism used for driving the focusing tube to rotate is arranged on the outer tube.

The invention has the following technical effects: the compact ranging and imaging integrated lens is provided, wherein the infrared imaging part comprises a first lens, a second lens, a focusing module and a lens holder, the first lens is mounted on the lens holder, the second lens is mounted on the focusing module, the ranging part comprises a laser transmitting lens set, a laser receiving lens set and a control processing module, the control processing module comprises a laser transmitting module, a laser receiving module and a control processing circuit board, the laser transmitting module and the laser receiving module are arranged on the control processing circuit board, the laser transmitting lens set and the laser receiving lens set are mounted on an edge of the lens holder and separated from each other, a first recess matched with the laser transmitting lens set and a second recess matched with the laser receiving lens set are formed in an edge of the first lens, and the control processing module is arranged behind the lens holder and located beyond an infrared imaging light path of the infrared imaging part. The ranging part is integrated in an infrared imaging lens, such that the laser transmitting lens set and the laser receiving lens set will not occupy space beyond the area where the first lens is located, and will not form obvious protrusions on the outside of the compact ranging and imaging integrated lens, thus making the compact ranging and imaging integrated lens more compact in overall structure, smaller in overall size, and easy to carry. The laser transmitting lens set and the laser receiving lens set are arranged on the edge of the lens holder and separated from each other, such that the influence on infrared imaging is reduced, and mutual interference between the laser transmitting unit and the laser receiving unit is reduced, thus improving the ranging accuracy of the compact ranging and imaging integrated lens.

### BRIEF DESCRIPTION OF THE SEVERAL VIEWS OF THE DRAWINGS

FIG. 1 is a schematic structural view according to the invention.

FIG. 2 is an exploded view according to the invention.

FIG. 3 is a sectional view according to the invention.

FIG. 4 is a schematic structural view of a first lens.

FIG. 5 is a schematic structural view of a lens holder.

FIG. 6 is a schematic structural view of a main tube.

FIG. 7 is a schematic structural view of a focusing lens holder.

FIG. 8 is a schematic structural view of a focusing tube.

FIG. 9 is a schematic structural view of a focusing gear.

In the FIGS.: 1, lens retaining ring; 201, laser transmitting lens set; 202, laser receiving lens set; 203, first lens; 203a, first recess; 203b, second recess; 204, lens holder; 204a, first mounting cavity; 204b, second mounting cavity; 205, control processing circuit board; 206, first connecting screw; 301, main tube; 301a, extension; 302, spring; 303, lens clamping ring; 304, second lens; 305, focusing lens holder; 305a, guide protrusion; 306, focusing tube; 306a, gear ring; 307, cover plate; 308, rotary wheel; 309, second connecting screw; 310, bearing; 311, focusing gear; 311a, gear shaft; 311b, gear body; 312, outer tube; 313, third connecting screw.

### DETAILED DESCRIPTION OF THE INVENTION

The technical solution of the invention is further described below in conjunction with specific embodiments.

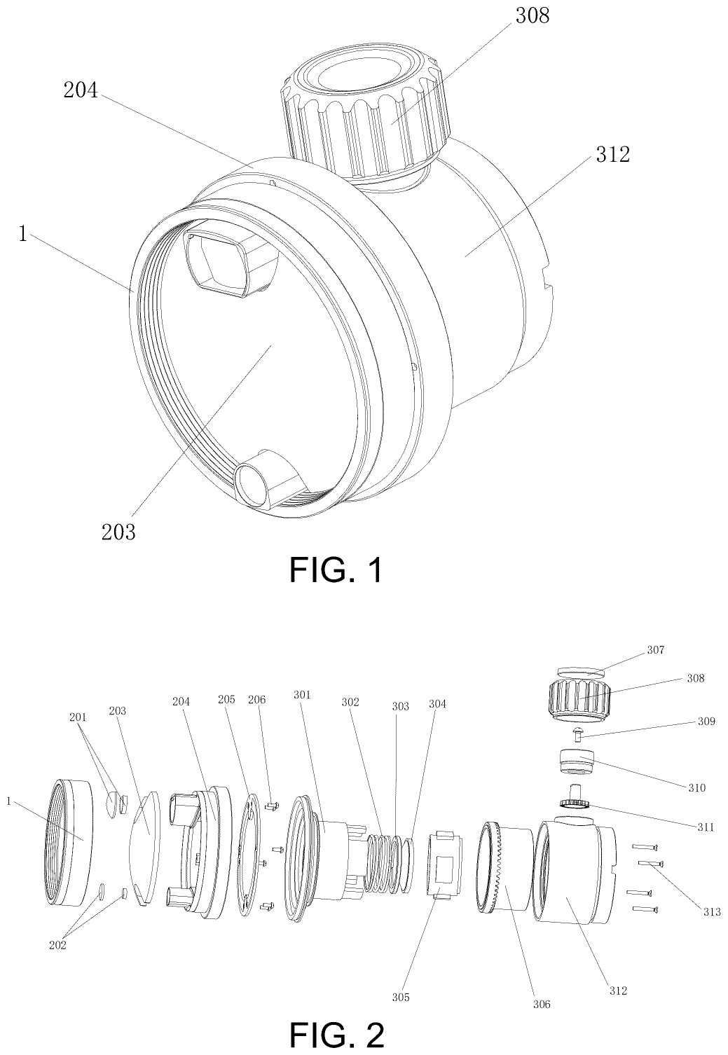

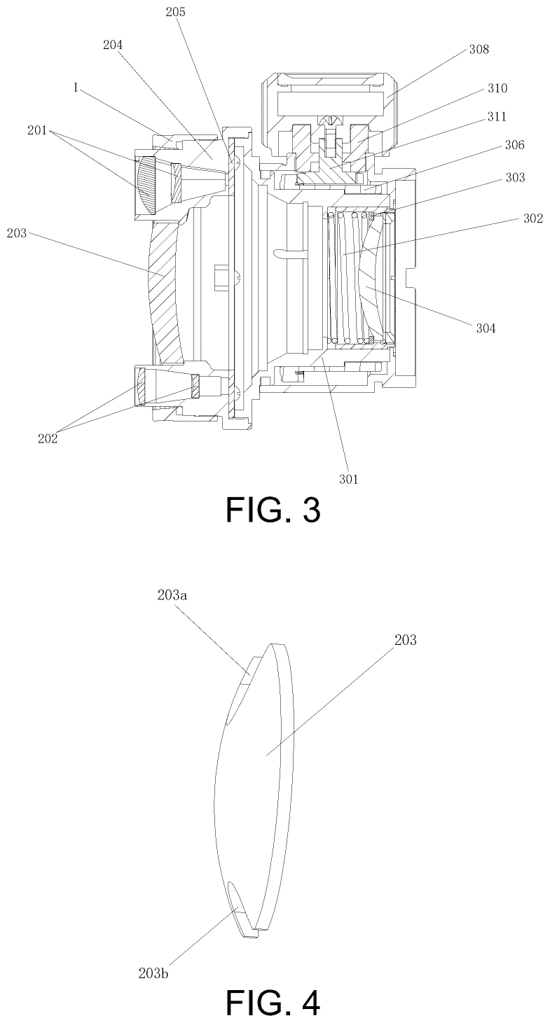

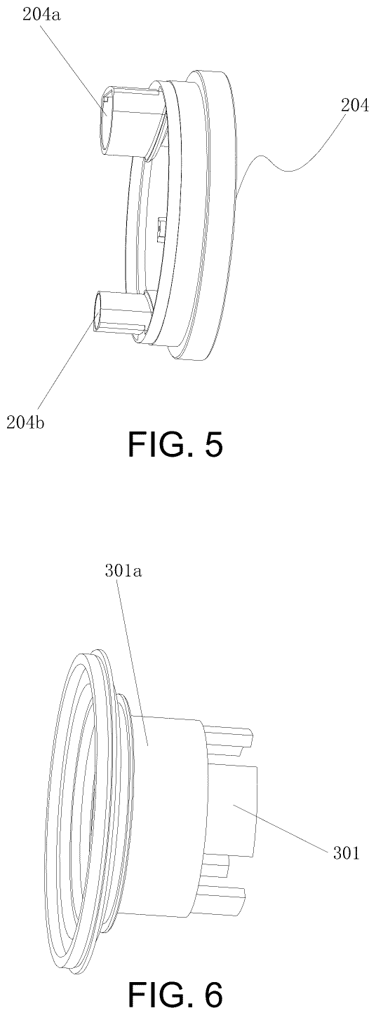

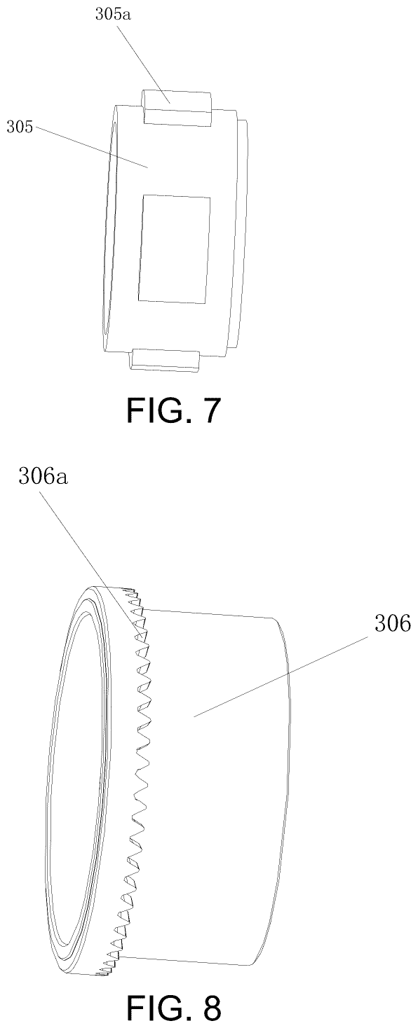

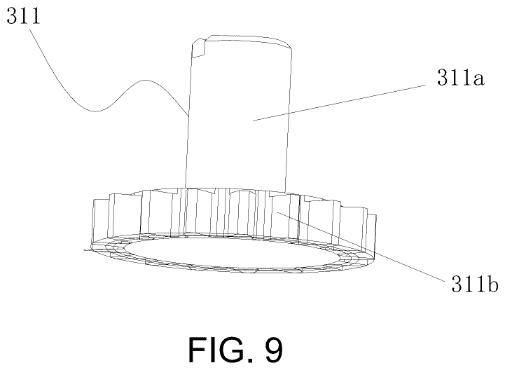

As shown in FIGS. 1-9, one specific embodiment of the invention provides a compact ranging and imaging integrated lens, comprising an infrared imaging part and a ranging part, wherein the infrared imaging part comprises a first lens 203, a second lens 304, a focusing module and a lens holder 204, the first lens 203 is mounted on the lens holder 204, the second lens 304 is mounted on the focusing module, the focusing module adjusts the second lens 304 to perform infrared imaging, the ranging part comprises a laser transmitting lens set 201, a laser receiving lens set 202 and a control processing module, the control processing module comprises a laser transmitting module (not shown), a laser receiving module (not shown) and a control processing circuit board 205, the laser transmitting module and the laser receiving module are arranged on the control processing circuit board 205, the laser transmitting lens set 201 and the laser receiving lens set 202 are mounted on an edge of the lens holder 204 and separated from each other, a first recess 203a matched with the laser transmitting lens set 201 and a second recess 203b matched with the laser receiving lens set 202 are formed in an edge of the first lens 203, and the control processing module is arranged behind the lens holder and located beyond an infrared imaging light path of the infrared imaging part.

As shown in FIGS. 1-9, the specific implementation process of the invention is as follows: the compact ranging and imaging integrated lens is provided, wherein the ranging part comprises the laser transmitting lens set 201, the laser receiving lens set 202 and the control processing module, the control processing module comprises the laser transmitting module (not shown), the laser receiving module (not shown) and the control processing circuit board 205, and the laser transmitting module and the laser receiving module are arranged on the control processing circuit board 205. Laser from the laser transmitting module is transmitted out in the form of a parallel beam by means of the laser transmitting lens set 201. The laser receiving lens set 202 receives laser reflected by a target and transmits the reflected laser back to the laser receiving module. The control processing module is located beyond the infrared imaging light path of the infrared imaging part, such that the infrared imaging light path will not be affected by the control processing module in the laser ranging process. The laser transmitting lens set 201 and the laser receiving lens set 202 are mounted on the edge of the lens holder 204 and separated from each other, and the first recess 203a matched with the laser transmitting lens set 201 and the second recess 203b matched with the laser receiving lens set 201 are formed in the edge of the first lens 203. Laser comes out via the first recess 203a after passing through the first lens 203. When received, the laser enters the laser receiving lens set 202 via the second recess 203b and is then transmitted back to the laser receiving module.

In a preferred embodiment of the invention, because the control processing module will generate heat in operation and the infrared imaging effect of the first lens 203 will be affected if the control processing module is too close to the first lens 203, in the invention, the control processing module is arranged behind the lens holder 204 to ensure that the infrared imaging quality will not be affected during ranging.

The laser transmitting module and the laser receiving module are arranged at two opposite ends in a radial direction of the control processing circuit board 205, and the laser transmitting lens set 201 and the laser receiving lens set 202 are correspondingly arranged at two opposite ends in a radial direction of the lens holder. The laser transmitting module corresponds to the laser transmitting lens set 201 in position, and the laser receiving module corresponds to the laser receiving module lens set 202 in position. The laser transmitting module is farthest away from the laser receiving module, such that the laser transmitting module and the laser receiving module are less likely to be affected by each other in operation.

The control processing circuit board 205 is arranged between a main tube 301 and the lens holder 204, and the laser transmitting module matched with the laser transmitting lens set 201 and the laser receiving module matched with the laser receiving lens set 202 are arranged on the control processing circuit board 205.

As shown in FIGS. 1-9, in the invention, the first lens 203 participates in infrared imaging of a target at a distance, and the laser transmitting lens set 201 and the laser receiving lens set 202 are arranged within a diameter range of the first lens 203, such that the laser transmitting lens set 201 and the laser receiving lens set 202 will not occupy space beyond the area where the first lens 203 is located, and will not form obvious protrusions on the outside of the compact ranging and imaging integrated lens, making the compact ranging and imaging integrated lens more compact in overall structure, smaller in overall size, and easy to carry. Wherein, the control processing circuit board 205 is used for generating laser and receiving laser reflected by the target. The laser transmitting lens set 201 is used for performing optical processing on the laser generated by the control processing circuit board 205, a parallel laser beam is formed after the laser passes through the laser transmitting lens set 201 and radiated to the target, and the laser receiving lens set 202 receives laser signals reflected by the target and converges the laser signals to the laser receiving module on the control processing circuit board 205 behind. The control processing circuit board 205 is ring-shaped, and light focused by the first lens 203 can pass through a hollow area in the middle of the control processing circuit board 205, such that imaging of an optical imaging system where the first lens 203 is located will not be affected.

Wherein, the laser transmitting lens set 201 and the laser receiving lens set 202 are respectively located on edges of two sides of the first lens 203. The laser transmitting lens set 201 and the laser transmitting module on the control processing circuit board 205 form a laser transmitting unit, and the laser receiving lens set 202 and the laser receiving module on the control processing circuit board 205 form a laser receiving unit. In the invention, the laser transmitting lens set 201 and the laser receiving lens set 202 are arranged at two ends of the diameter of the first lens 102. In this way, the laser transmitting lens set 201 and the laser receiving lens set 202 are located within the range of the first lens 203 and the distance between the laser transmitting lens set 201 and the laser receiving lens set 202 is maximized. By maximizing the distance between the laser transmitting lens set 201 and the laser receiving lens set 202, mutual interference between the laser transmitting unit and the laser receiving unit can be reduced, and the ranging accuracy of the compact ranging and imaging integrated lens is improved. In addition, because a main imaging area of the first lens 203 is the central area of the first lens 203, the laser transmitting lens set 201 and the laser receiving lens set 202 are arranged on the edge of the first lens 203 to greatly reduce the influence on the imaging effect of the first lens 203, thus improving the imaging quality.

As shown in FIGS. 1-9, the compact ranging and imaging integrated lens provided by the invention further comprises a main tube 301, an outer tube 312, a focusing tube 306, a focusing lens holder 305 and the second lens 304, wherein the second lens 304 is arranged on the focusing lens holder 305, and a spring 302 is arranged between the focusing lens holder 305 and the main tube 301; the focusing lens holder 305 is slidably connected to the main tube 301; the focusing lens holder 305 is arranged in the focusing tube 306, and the focusing tube 306 is in thread fit with the focusing lens holder 305; one end of the main tube 301 is connected to the lens holder 204, and the other end of the main tube 301 is fixedly connected to the outer tube 312; the focusing tube 306 is arranged between the outer tube 312 and the focusing lens holder 305, and a rotation driving mechanism for driving the focusing tube 306 to rotate is arranged on the outer tube 312. Wherein, the control processing circuit board 205 is fixedly connected to the lens holder 204 by means of first connecting screws 206, and one end of the main tube 301 is threadedly connected to the lens holder 204. During focusing, the focusing lens holder 305 is slidably connected to the main tube 301, such that the focusing lens holder 305 can only move with respect to the main tube 301 in an axial direction of the main tube 301 and cannot rotate with respect to the main tube 301. During focusing, the rotation driving mechanism drives the focusing tube 306 to rotate with respect to the focusing lens holder 305; because the focusing tube 306 is in thread fit with the focusing lens holder 305, the focusing lens holder 305 will be driven to move in the axial direction of the main tube 301 when the focusing tube 306 rotates, so as to drive the second lens 304 to move synchronously to adjust the distance between the first lens 203 and the second lens 304, thus fulfilling a focusing function. The spring 302 is arranged between the focusing lens holder 305 and the main tube 301 and applies a pressure to the second lens 304 and the focusing lens holder 305 to compensate for a thread fit clearance between the focusing tube 306 and the focusing lens holder 305, thus improving the stability and focusing accuracy of a focusing system.

As shown in FIGS. 1-9, a gear ring 306a is arranged on an outer side of the focusing tube 306, the rotation driving mechanism comprises a focusing gear 311 rotatably connected to the outer tube 312, the focusing gear 311 is engaged with the gear ring 306a on the focusing tube 306, and a rotary wheel 308 is connected to the focusing gear 311. During focusing, the rotary wheel 308 is rotated to drive the focusing gear 311 to rotate, and when rotating, the focusing gear 311 drives the focusing tube 306 to rotate to drive the second lens 304 to move.

The focusing gear 311 comprises a gear body 311b and a gear shaft 311a arranged on the gear body 311b, a bearing 310 is arranged on the outer tube 312, the gear shaft 311a is connected to the bearing 310, and the rotary wheel 308 is connected to the gear shaft 311a. The rotary wheel 308 is fixedly connected to the gear shaft 311a by means of second connecting screws 309. A cover plate 307 is arranged on the rotary wheel 308.

Wherein, extensions 301a are arranged at an end, away from the lens holder 204, of the main tube 301 and extend in the axial direction of the main tube 301, guide grooves are formed between the adjacent extensions 301a, guide protrusions 305a are arranged on an outer side of the focusing lens holder 305, and the guide protrusions 305a are clamped in the guide grooves and are able to slide along the guide grooves; external threads are arranged on the guide protrusions 305a, and internal threads matched with the external threads are arranged on an inner side of the focusing tube 306. The extensions 301a on the main tube 301 are fixedly connected to the outer tube 312 by means of third connecting screws 313.

A lens clamping ring 303 is arranged between the spring 302 and the second lens 304 and used for enlarging a contact area between the spring 302 and the second lens 304 to improve the stress uniformity of the second lens 304, thus preventing the second lens 304 from being partially crushed.

As shown in FIGS. 1-9, in a preferred embodiment of the invention, a lens retaining ring 1 is connected to the lens holder 204, and the first lens 203 is sandwiched between the lens retaining ring 1 and the lens holder 204. The lens retaining ring 1 is threadedly connected to the lens holder 204.

As shown in FIGS. 1-9, in a preferred embodiment of the invention, a first mounting cavity 204a and a second mounting cavity 204b are formed in the lens holder 204, the laser transmitting lens set is mounted in the first mounting cavity 204a, and the lens receiving lens set is mounted in the second mounting cavity 204b.

As shown in FIGS. 1-9, in a preferred embodiment of the invention, the control processing circuit board 205 is ring-shaped, such that the infrared imaging light path will not be affected by the control processing circuit board 205.

The invention is described in further detail above in conjunction with specific preferred embodiments, but the specific implementation of the invention should not be limited to the above description. For those ordinarily skilled in the art, some simple deductions or substitutions can be made without departing from the concept of the invention, and all these deductions or substitutions should also fall within the protection scope of the invention.

What is claimed is:

1. A compact ranging and imaging integrated lens, comprising an infrared imaging part and a ranging part, wherein the infrared imaging part comprises a first lens, a second lens, a focusing module and a lens holder, the first lens is mounted on the lens holder, the second lens is mounted on the focusing module, the ranging part comprises a laser transmitting lens set, a laser receiving lens set and a control processing module, the control processing module comprises a laser transmitting module, a laser receiving module and a control processing circuit board, the laser transmitting module and the laser receiving module are arranged on the control processing circuit board, the laser transmitting lens set and the laser receiving lens set are mounted on an edge of the lens holder and separated from each other, a first recess matched with the laser transmitting lens set and a second recess matched with the laser receiving lens set are formed in an edge of the first lens, and the control processing module is arranged behind the lens holder and located beyond an infrared imaging light path of the infrared imaging part.

2. The compact ranging and imaging integrated lens according to claim 1, wherein a first mounting cavity and a second mounting cavity are formed in the lens holder, the laser transmitting lens set is mounted in the first mounting cavity, and the lens receiving lens set is mounted in the second mounting cavity.

3. The compact ranging and imaging integrated lens according to claim 1, wherein the control processing circuit board is ring-shaped.

4. The compact ranging and imaging integrated lens according to claim 1, wherein the laser transmitting module and the laser receiving module are arranged at two opposite ends of the control processing circuit board, and the laser transmitting lens set and the laser receiving lens set are correspondingly arranged at two opposite ends of the lens holder.

5. The compact ranging and imaging integrated lens according to claim 1, wherein the focusing module comprises a main tube, a focusing tube and a focusing lens holder, the second lens is arranged on the focusing lens holder, and a spring is arranged between the focusing lens holder and the main tube.

6. The compact ranging and imaging integrated lens according to claim 5, further comprising an outer tube, wherein a gear ring is arranged on an outer side of the focusing tube, a rotation driving mechanism comprises a focusing gear rotatably connected to the outer tube, the focusing gear is engaged with the gear ring on the focusing tube, and a rotary wheel is connected to the focusing gear.

7. The compact ranging and imaging integrated lens according to claim 5, wherein the focusing lens holder is slidably connected to the main tube and arranged in the focusing tube, and the focusing tube is in thread fit with the focusing lens holder.

8. The compact ranging and imaging integrated lens according to claim 5, wherein extensions are arranged at an end, away from the lens holder, of the main tube and extend in an axial direction of the main tube, guide grooves are formed between adjacent said extensions, guide protrusions are arranged on an outer side of the focusing lens holder, and the guide protrusions are clamped in the guide grooves and are able to slide along the guide grooves.

9. The compact ranging and imaging integrated lens according to claim 5, wherein the focusing lens holder is arranged in the focusing tube and slidably connected to the main tube, and the focusing tube is in thread fit with the focusing lens holder.

10. The compact ranging and imaging integrated lens according to claim 5, further comprising an outer tube, wherein the outer tube has an end connected to the lens holder and an end fixedly connected to the outer tube, the focusing tube is arranged between the outer tube and the focusing lens holder, and a rotation driving mechanism used for driving the focusing tube to rotate is arranged on the outer tube.
